(19) United States
(12) Patent Application Publication
(10) Pub. No.: US 2002/0169780 A1
(43) Pub. Date: Nov. 14, 2002

(54) Method and data processing system for providing disaster recovery file synchronization

(75) Inventor: Edward George Mraz, Glendale, AZ (US)

Correspondence Address: John S. Solakian Esq., Law Office - M/S B55, Bull HN Information Systems Inc., 13430 North Black Canyon Highway, Phoenix, AZ, 85029-1310, US

(73) Assignee: Bull HN Information Systems Inc.

(21) Appl. No.: 09/854,165

(22) Filed: May 11, 2001

(51) Int. Cl. G06F 7/00

(52) U.S. Cl. 707/100

(57) ABSTRACT

In order to maintain consistent file systems for disaster recovery purposes between two computer systems, the file names from a first computer system are copied into a first database and the file names from a second computer system are copied into a second database. The file names in the two databases are then compared for duplicates. Based on a switch, a list of either duplicated or unduplicated file names is generated. The file names in the generated list are filtered, if desired, and then displayed. A user then has the ability to review the list of generated file names and select some or all of them for duplication or deletion, as required.

### FIELD OF THE INVENTION

The present invention generally relates to data processing systems, and more specifically to providing synchronization between file systems in two data processing systems.

### BACKGROUND OF THE INVENTION

Large scale data processing systems today utilize large numbers of disk drives for on-line access to data. In the case of mission critical applications, these disk drives are often replicated.

One problem that must be considered with data processing systems with mission critical applications is to provide disaster recovery. One solution for disaster recovery is to provide for duplicated data processing systems. One problem that arises in preparing for disaster recovery is that files are continually being added and deleted from the original disks. Keeping files continuously synchronized between the two data processing systems is often quite hard to do.

It would thus be advantageous to provide a mechanism to determine which files on one data processing system were present on the second data processing system, and which were not.

### BRIEF DESCRIPTION OF THE DRAWINGS

The features and advantages of the present invention will be more clearly understood from the following detailed description taken in conjunction with the accompanying FIGURES where like numerals refer to like and corresponding parts and in which:

FIG. 1 is a block diagram illustrating a General Purpose Computer 20 in a data processing system; and

FIG. 2 is a flowchart that illustrates operation of the present invention, in accordance with a preferred embodiment of the present invention.

### DETAILED DESCRIPTION

In order to maintain consistent file systems for disaster recovery purposes between two computer systems, the file names from a first computer system are copied into a first database and the file names from a second computer system are copied into a second database. The file names in the two databases are then compared for duplicates. Based on a switch, a list of either duplicated or unduplicated file names is generated. The file names in the generated list are filtered, if desired, and then displayed. A user then has the ability to review the list of generated file names and select some or all of them for duplication or deletion, as required.

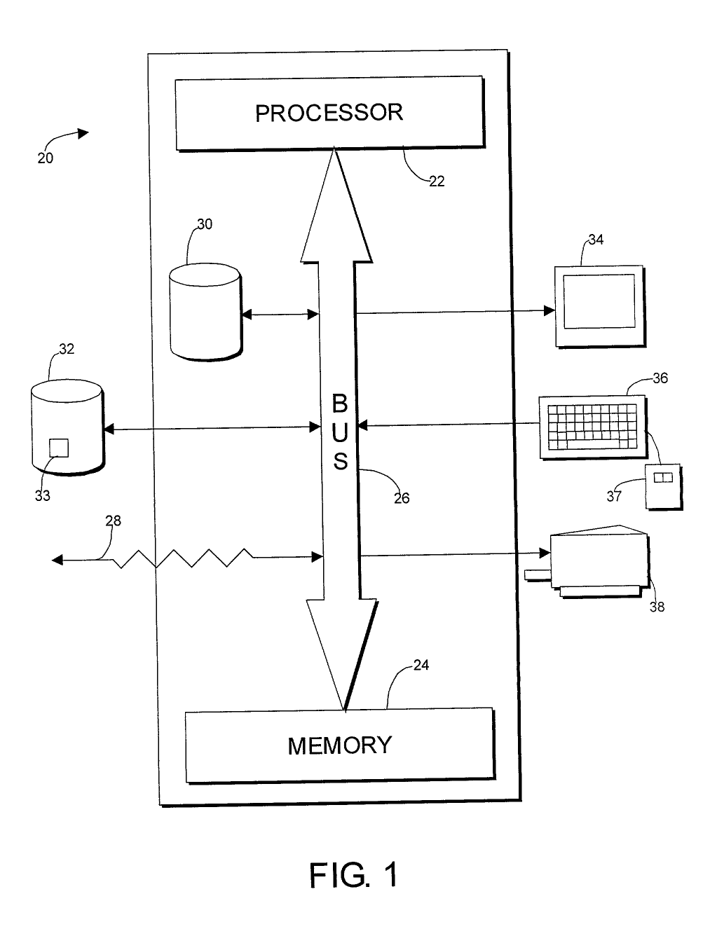

FIG. 1 is a block diagram illustrating a General Purpose Computer 20 in a data processing system. The General Purpose Computer 20 has a Computer Processor 22, and Memory 24, connected by a Bus 26. Memory 24 is a relatively high speed machine readable medium and includes Volatile Memories such as DRAM, and SRAM, and Non-Volatile Memories such as, ROM, FLASH, EPROM, and EEPROM. Also connected to the Bus are Secondary Storage 30, External Storage 32, output devices such as a monitor 34, input devices such as a keyboard 36 (with mouse 37), and printers 38. Secondary Storage 30 includes machine-readable media such as hard disk drives (or DASD). External Storage 32 includes machine-readable media such as floppy disks, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such as data base management software, operating systems, and user programs can be stored in a Computer Software Storage Medium, such as memory 24, Secondary Storage 30, and External Storage 32. Executable versions of computer software 33, can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

The present invention involves a pair of data processing systems. One system is the primary system, and the other is the system utilized for disaster recovery. In one type of disaster recovery system, critical files are duplicated on both systems. In such a case, it is important that no critical files are unduplicated. In a second type of disaster recovery system, it is important that critical files not be duplicated since in the case of a disaster, they will be brought online along side the critical files on the system utilized for disaster recovery.

The present invention then provides a mechanism to efficiently compare file names from the two data processing systems, to determine which file names are duplicated, and which are not, to generate a display of this information, and to generate JCL to rectify any problems that become evident when the display is reviewed.

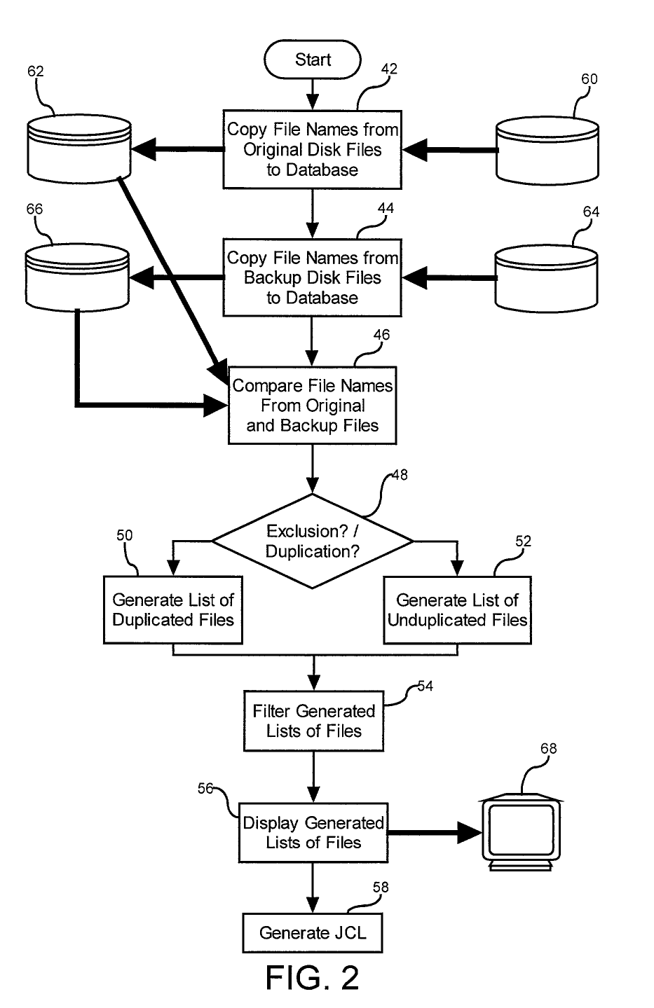

FIG. 2 is a flowchart that illustrates operation of the present invention, in accordance with a preferred embodiment of the present invention. It starts by copying file or path names for the disk drives 60 of a first data processing system into a first database 62, step 42. It then copies the file or path names for disk drives 66 from a second data processing system into a second database 64, step 44. The two sets of file names in the two databases 62, 66 are compared for duplicates, step 46. A test is made whether to display duplicates or unduplicated file names, step 48. Based on this test, a list of either duplicated file names is generated, step 50, or a list of unduplicated file names is generated, step 52. In either case, the generated list of files is displayed, step 56, on a terminal or display device 68. It should be noted that while two databases 62, 66, are shown, this is done for demonstration purposes, and the use of a single database containing both sets of file or path names is within the scope of this invention. Also, it is possible to implement the present invention utilizing sorting of file names instead of databases. However, such an implementation is more complex and less flexible and user friendly.

The display of files can also be controlled by selection criteria and filtering, step 54. For example, a list of files to ignore can be filtered out. This list can either include specific files, or files with certain types of file names, or files of certain types. Thus, for example, scratch files can be filtered out of the display.

The display is either based on the file (or path) name, or on the device or volume on which the files exist. In the case where file or path names form a tree structure, as is common in many computer system architectures, a tree of path names can be opened up and closed up a level at a time, if desired, by clicking on the path name in a manner familiar to users of personal computers. File properties are also hidden or displayed through either clicking or other methods of selection.

A hard copy of the remaining duplicated or unduplicated files can then be printed out in hard copy form (not shown). Alternatively, or additionally, some or all of the duplicated or unduplicated files, as selected, can be selected for further action. JCL can then be generated, step 58, to duplicate them on the backup drives in the case of unduplicated files, or to delete them from the backup drives in the case of duplicated files.

The preferred embodiment is implemented on a Microsoft Windows 95/98/NT/2000 computer system utilizing Microsoft Access database(s). The display 68 is similar to the file displays utilized by Windows and thus provides users a user-friendly environment that they are used to.

The present invention greatly simplifies the administration of large numbers of files on large numbers of disk drives for disaster recovery purposes. It not only makes such administration much easier and more efficient, it also makes it significantly more error free.

Those skilled in the art will recognize that modifications and variations can be made without departing from the spirit of the invention. Therefore, it is intended that this invention encompass all such variations and modifications as fall within the scope of the appended claims.

claim elements and steps herein have been numbered and/or lettered solely as an aid in readability and understanding. As such, the numbering and/or lettering in itself is not intended to and should not be taken to indicate the ordering of elements and/or steps in the claims.

What is claimed is:

1. A method of maintaining consistent file systems between a first computer system and a second computer system, wherein:
the first computer system has a first file system comprising a first set of disks containing a first set of disk files;
the second computer system has a second file system comprising a second set of disks containing a second set of disk files;
said method comprising:
A) copying a first set of file names corresponding to the first set of disk files to a first database;
B) copying a second set of file names corresponding to the second set of disk files to a second database;
C) comparing the first set of file names in the first database to the second set of file names in the second database;
D) generating an unfiltered list of file names from the comparing in step (C); and
E) filtering the unfiltered list of file names generated in step (D) into a filtered list of file names.

2. The method in claim 1 which further comprises:
F) displaying the filtered list of file names.

3. The method in claim 1 which further comprises:
F) displaying the unfiltered list of file names.

4. The method in claim 1 which further comprises:
F) generating JCL from the filtered list of file names to synchronize the first set of files with the second set of files.

5. The method in claim 1 which further comprises:
G) executing the JCL generated in step (F) to synchronize the first set of files with the second set of files.

6. The method in claim 1 wherein:
step (D) comprises:
selecting file names determined in step (C) to exist in the first set of file names and to not exist in the second set of file names to be in the unfiltered list of file names.

7. The method in claim 6 wherein:
step (D) further comprises:
selecting file names determined in step (C) to not exist in the first set of file names and to exist in the second set of file names to be in the unfiltered list of file names.

8. The method in claim 1 wherein:
step (D) comprises:
selecting file names determined in step (C) to exist in the first set of file names and to exist in the second set of file names to be in the unfiltered list of file names.

9. The method in claim 1 which further comprises:
F) determining whether to generate a duplicate list of file names or an unduplicated list of file names before step (D).

10. A method of maintaining consistent file systems between a first computer system and a second computer system, wherein:
the first computer system has a first file system comprising a first set of disks containing a first set of disk files;
the second computer system has a second file system comprising a second set of disks containing a second set of disk files;
said method comprising:
A) copying a first set of file names corresponding to the first set of disk files to a first database;
B) copying a second set of file names corresponding to the second set of disk files to a second database;
C) comparing the first set of file names in the first database to the second set of file names in the second database;
D) determining whether to generate a duplicate list of file names or an unduplicated list of file names before step (E);
E) generating an unfiltered list of file names from the comparing in step (C), wherein:
when step (D) determines that a duplicate list of file names is to be generated, the unfiltered list of file names contains file names that exist in the first set of file names and exists in the second set of file names; and
when step (D) determines that an unduplicated list of file names is to be generated, the unfiltered list of file names contains file names that exist in the first set of file names and that do not exist in the second set of file names, and contains file names that exist in the second set of file names and that do not exist in the first set of file names; and
F) filtering the unfiltered list of file names generated in step (E) into a filtered list of file names.

11. Software stored in a Computer Software Storage Medium for maintaining consistent file systems between a first computer system and a second computer system, wherein:
the first computer system has a first file system comprising a first set of disks containing a first set of disk files;
the second computer system has a second file system comprising a second set of disks containing a second set of disk files;
said software comprising:
A) a set of computer instructions for copying a first set of file names corresponding to the first set of disk files to a first database;
B) a set of computer instructions for copying a second set of file names corresponding to the second set of disk files to a second database;
C) a set of computer instructions for comparing the first set of file names in the first database to the second set of file names in the second database;
D) a set of computer instructions for generating an unfiltered list of file names from the comparing in set (C); and
E) a set of computer instructions for filtering the unfiltered list of file names generated in set (D) into a filtered list of file names.

12. The software in claim 11 which further comprises:
F) a set of computer instructions for displaying the filtered list of file names.

13. The software in claim 11 which further comprises:
F) a set of computer instructions for displaying the unfiltered list of file names.

14. The software in claim 11 which further comprises:
F) a set of computer instructions for generating JCL from the filtered list of file names to synchronize the first set of files with the second set of files.

15. The software in claim 11 wherein:
the first database and the second database are a single database;
a file name in the first set of file names is identified with a first code in the single database; and
a file name in the second set of file names is identified with a second code in the single database.

16. The software in claim 11 wherein:
set (D) comprises:
a set of computer instructions for selecting file names determined in set (C) to exist in the first set of file names and to not exist in the second set of file names to be in the unfiltered list of file names.

17. The software in claim 16 wherein:
set (D) further comprises:
a set of computer instructions for selecting file names determined in set (C) to not exist in the first set of file names and to exist in the second set of file names to be in the unfiltered list of file names.

18. The software in claim 11 wherein:
set (D) comprises:
a set of computer instructions for selecting file names determined in set (C) to exist in the first set of file names and to exist in the second set of file names to be in the unfiltered list of file names.

19. The software in claim 11 which further comprises:
F) a set of computer instructions for determining whether to generate a duplicate list of file names or an unduplicated list of file names before set (D).

20. A computer readable Non-Volatile Storage Medium encoded with software for maintaining consistent file systems between a first computer system and a second computer system, wherein:
the first computer system has a first file system comprising a first set of disks containing a first set of disk files;
the second computer system has a second file system comprising a second set of disks containing a second set of disk files;
said software comprising:
A) a set of computer instructions for copying a first set of file names corresponding to the first set of disk files to a first database;
B) a set of computer instructions for copying a second set of file names corresponding to the second set of disk files to a second database;
C) a set of computer instructions for comparing the first set of file names in the first database to the second set of file names in the second database;
D) a set of computer instructions for generating an unfiltered list of file names from the comparing in set (C); and
E) a set of computer instructions for filtering the unfiltered list of file names generated in set (D) into a filtered list of file names.
